(19) United States
(12) Patent Application Publication
(10) Pub. No.: US 2026/0019274 A1
(43) Pub. Date: Jan. 15, 2026

(54) METHOD, APPARATUS, DEVICE AND STORAGE MEDIUM FOR KEY MANAGEMENT

(71) Applicants: DOUYIN VISION CO., LTD., Beijing (CN); Lemon Inc., Grand Cayman (KY)

(72) Inventors: Ming Qing Foo, Singapore (SG); Hong Kun Chee, Singapore (SG); Ming Xuan Chai, Singapore (SG); Ahnaf Aff Siddiqi, Singapore (SG); Guangshuai Xia, Beijing (CN); Qing Zhang, Beijing (CN); Weiji Shi, Los Angeles, CA (US); Xuanming Dong, Los Angeles, CA (US); Yuwei Zheng, Beijing (CN); Wei Min Teo, Singapore (SG); Kenneth Jian Hui Sim, Singapore (SG); Zhuli Meng, Beijing (CN)

(21) Appl. No.: 19/070,629

(22) Filed: Mar. 5, 2025

(30) Foreign Application Priority Data
Jul. 9, 2024 (CN) 202410917968.4

(51) Int. Cl. H04L 9/32; H04L 9/08

(52) U.S. Cl. CPC H04L 9/3247; H04L 9/0891; H04L 9/3263

(57) ABSTRACT

According to embodiments of the disclosure, a method, an apparatus, a device and a storage medium for key management are provided. The method includes: sending a signing request for an application to a key management service, the signing request including target data to be signed for the application; receiving a digital signature for the application from the key management service, the digital signature being obtained by encrypting the target data with a target key for the application; and generating a release version of the application based on the digital signature. The key management service proposed in the disclosure is easy to integrate with application development process, thus promoting developers to use the key management service to store keys instead of storing keys locally in a scattered manner. Thus, the problems of key leakage and unauthorized key use can be solved.

### CROSS-REFERENCE

The present application claims priority to Chinese Patent Application No. 202410917968.4, filed on Jul. 9, 2024, and entitled “METHOD, APPARATUS, DEVICE AND STORAGE MEDIUM FOR KEY MANAGEMENT”, the entirety of which is incorporated herein by reference.

### FIELD

Example embodiments of the subject matter described herein generally relate to the field of computer, and in particular, to a method, an apparatus, a device and a computer-readable storage medium for key management.

### BACKGROUND

In the current digital world, the importance of information security is becoming more and more prominent. As an important component of information security, key management plays a crucial role in information security. Key management is also an important part of application development. Therefore, it is expected to solve the contradiction between key security and convenience by managing keys.

### SUMMARY

In a first aspect of the subject matter described herein, there is provided a method for key management. The method includes: sending a signing request for an application to a key management service, the signing request including target data to be signed for the application; receiving a digital signature for the application from the key management service, the digital signature being obtained by encrypting the target data with a target key for the application; and generating a release version of the application based on the digital signature.

In a second aspect of the subject matter described herein, there is provided a method for key management. The method includes: receiving, from an application development side, a signing request for an application, the signing request including target data to be signed for the application; obtaining a digital signature for the application by encrypting the target data with a target key for the application; and sending the digital signature to the application development side for generating a release version of the application.

In a third aspect of the subject matter described herein, there is provided an apparatus for key management. The apparatus includes: a request sending module configured to send a signing request for an application to a key management service, the signing request including target data to be signed for the application; a signature receiving module configured to receive a digital signature for the application from the key management service, the digital signature being obtained by encrypting the target data with a target key for the application; and a version generating module configured to generate a release version of the application based on the digital signature.

In a fourth aspect of the subject matter described herein, there is provided an apparatus for key management. The apparatus includes: a request receiving module configured to receive, from an application development side, a signing request for an application, the signing request including target data to be signed for the application; a signature generating module configured to obtain a digital signature for the application by encrypting the target data with a target key for the application; and a signature sending module configured to send the digital signature to the application development side for generating a release version of the application.

In a fifth aspect of the subject matter described herein, there is provided an electronic device. The device includes at least one processing unit and at least one memory, the at least one memory being coupled to the at least one processing unit and storing instructions executable by the at least one processing unit. The instructions, when executed by the at least one processing unit, cause the device to perform the method of the first aspect.

In a sixth aspect of the subject matter described herein, there is provided a computer-readable storage medium. The computer-readable storage medium has stored thereon a computer program executable by a processor to implement the method of the first aspect.

It should be understood that the content described in this section is not intended to limit the key or important features of the embodiments of the subject matter described herein, nor is it intended to limit the scope of the subject matter described herein. Other features of the subject matter described herein will become readily apparent from the following description.

### BRIEF DESCRIPTION OF THE DRAWINGS

The above and other features, advantages, and aspects of the subject matter described herein will become more apparent when taken in conjunction with the drawings and with reference to the following detailed description. In the drawings, the same or similar reference numbers refer to the same or similar elements, in which:

FIG. 1 illustrates a schematic diagram of an example environment in which embodiments of the subject matter described herein may be implemented;

FIG. 2 illustrates a schematic diagram of an example architecture for key management according to some embodiments of the subject matter described herein;

FIG. 3 illustrates a schematic diagram of an example architecture for generating a release version of an application using a plug-in according to some embodiments of the subject matter described herein;

FIG. 4 illustrates a schematic diagram of another example architecture for generating a release version of an application using a plug-in according to some embodiments of the subject matter described herein;

FIG. 5 illustrates a schematic diagram of still another example architecture for generating a release version of an application using a plug-in according to some embodiments of the subject matter described herein;

FIG. 6A illustrates a flowchart of a process for key management according to some embodiments of the subject matter described herein;

FIG. 6B illustrates a flowchart of a process for key management according to some embodiments of the subject matter described herein;

FIG. 7A illustrates a schematic structural block diagram of an apparatus for key management according to some embodiments of the subject matter described herein;

FIG. 7B illustrates a schematic structural block diagram of an apparatus for key management according to some embodiments of the subject matter described herein; and

FIG. 8 illustrates a block diagram of a device capable of implementing multiple embodiments of the subject matter described herein.

### DETAILED DESCRIPTION

It can be understood that before using the technical solutions disclosed in the embodiments of the present disclosure, the user should be informed of the type, use scope, use scenario, etc. of the personal information involved in the present disclosure and the user's authorization should be obtained through an appropriate manner in accordance with relevant laws and regulations.

For example, in response to receiving an active request from a user, prompt information is sent to the user to explicitly prompt the user that an operation requested by the user will need to acquire and use the user's personal information. Thus, the user may independently select whether to provide personal information to software or hardware such as an electronic device, an application, a server or a storage medium that performs an operation of the technical solution of the present disclosure according to the prompt information.

As an optional but non-limiting implementation, the manner of sending the prompt information to the user in response to receiving the active request from the user may be, for example, a pop-up window in which the prompt information may be presented in text. In addition, the pop-up window may also carry a selection control for the user to select “agree” or “disagree” to provide personal information to the electronic device.

It can be understood that the above process of notifying and obtaining user authorization is only schematic, and does not constitute a limitation on the implementations of the present disclosure. Other manners that satisfy relevant laws and regulations may also be applied to the implementations of the present disclosure.

It can be understood that data involved in the technical solution (including but not limited to the data itself, the acquisition or use of the data) should comply with the requirements of corresponding laws and regulations and related provisions.

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for purpose of example and are not intended to limit the scope of protection of the present disclosure.

It should be noted that the title of any section/sub-section provided herein is not limiting. Various embodiments are described throughout this document, and any type of embodiment may be included under any section/sub-section. In addition, the embodiments described in any section/sub-section may be combined in any manner with any other embodiments described in the same section/sub-section and/or different section/sub-section.

In this document, unless explicitly stated, performing a step “in response to A” does not mean that the step is performed immediately after “A”, but may include one or more intermediate steps.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may be included hereinafter. The terms “first” and “second” may refer to different or same objects. Other explicit and implicit definitions may be included hereinafter.

As briefly mentioned above, as an important component of information security, key management is an important part of application development. At present, software applications (APPs) running on various operating systems are digitally signed with asymmetric private keys (which may also be referred to as “application signing keys”), and the signatures are embedded in the applications. Correspondingly, a terminal device also embeds a certificate containing the public part of the application signing key into the application. The certificate may be self-signed with the application signing key or signed by a certificate authority. The application signing key should be generated and stored securely by the application developer, while the certificate may be freely distributed. The certificate and the signature allow the user to verify that the application has not been tampered with and that the application comes from a trusted source.

If an application has already been installed on the device, the operating system requires that updated versions of the application be signed with the same key in order to update the existing application. The operating system may also support key rotation, which allows developers to change their application signing keys. The build process of the APP creates binary packages that may be installed on corresponding devices of the operating system, respectively. The binary packages usually involve compiling, linking, packaging, signing and deploying steps. It should be understood that applications for different operating systems may be published in different formats. For example, an application on one type of operating system may be published in apk and aab formats. An application on another type of operating system may be published in app and hap formats.

Further, applications need to be signed in a build pipeline, which may rely on build tools to run tests, compile source code and perform other continuous integration/continuous delivery tasks. Different operating systems may have different application build tools. However, some developers may choose not to use application build tools for signing. Instead, they may rely on stand-alone software tools to perform signing. Any solution for protecting application signing keys must conform to various build pipelines, which may or may not rely on application build tools.

The application may be signed on a personal developer's computer. In these cases, different developers in the same development team may share the same application signing key, that is, the application signing key is copied and distributed. On the other hand, the application may also be signed in a build pipeline hosted on the cloud, and the cloud usually lacks protection for the application signing key. These solutions described above have a high risk of key leakage. An attacker who steals the application signing key may publish a backdoor version of the application, and users who install this backdoor version will face risks of data theft and account takeover.

It can be seen that the current key management solution is not user-friendly because it lacks integration with the development pipeline. In other words, there is currently a lack of a consistent or structured application signing key management method. In addition, solutions for protecting application signing keys must conform to various build strategies for applications.

In view of this, embodiments of the present disclosure provide a solution for key management. According to various embodiments of the present disclosure, a key management service hosts keys required in application development. An application development side sends a signing request for an application to the key management service, the signing request including target data to be signed for the application. After receiving the signing request, the key management service encrypts the target data with a target key for the application to obtain a digital signature. Subsequently, the application development side receives the digital signature for the application from the key management service, and generates a release version of the application according to the digital signature.

In this way, keys in application development are hosted by an independent key management service instead of being scattered on devices of respective developers. Thus, the problem of key leakage can be solved. In addition, the verification and authorization of keys can be controlled by using a unified key management service to ensure that keys are only used by authorized users. This can prevent the problem of unauthorized key use.

Some example embodiments of the subject matter described herein will be described below with continued reference to the drawings.

### Example Environment

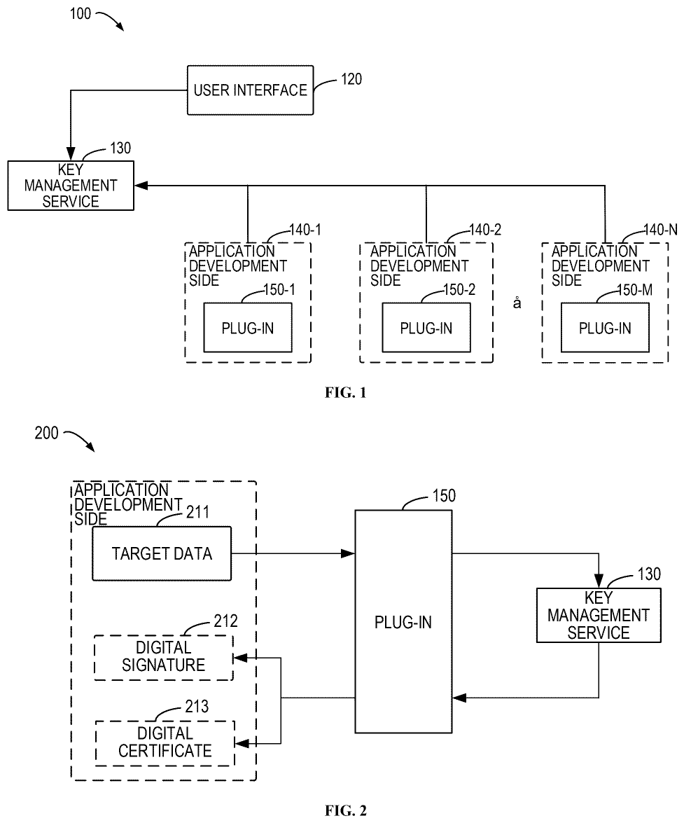

FIG. 1 illustrates a schematic diagram of an example environment 100 in which embodiments of the subject matter described herein may be implemented. The environment 100 includes one or more application development sides 140-1, 140-2, . . . , 140-N, each of which may correspond to a different development workflow. For ease of discussion, the application development sides 140-1, 140-2, . . . , 140-N may be collectively or individually referred to as an application development side 140, and the application development side 140 may be implemented at an electronic device, e.g., a terminal device or a server. In the environment 100, a key management service 130 is deployed, and the key management service 130 may be implemented at a server, e.g., a cloud server. The key management service 130 is configured to host an application signing key and provide an application programming interface (API) for encryption, digital signature and certificate management. Correspondingly, the key management service 130 can securely store the application signing key in a software vault or a hardware security module, where a private part never leaves the service. In some embodiments, the application development side 140 sends a signing request for an application under development to the key management service 130 to generate a release version of the application.

An application is usually developed in a development workflow (also referred to as a build pipeline). In some embodiments, plug-ins 150-1, 150-2, . . . , 150-M may be introduced into the build pipelines of the application development sides 140-1, 140-2, . . . , 140-N. For ease of discussion, the plug-ins 150-1, 150-2, . . . , 150-M may be collectively or individually referred to as a plug-in 150, and the plug-in 150 is a software module that integrates the key management service 130 with the application under development (sometimes also referred to as “the user's build pipeline”). The plug-in 150 intercepts a signing operation by sending a signing payload to the key management service 130 and receiving a signature. A new plug-in 150 may be flexibly created by invoking an application programming interface (API) provided by the key management service 130. In some embodiments, in the process of generating the release version of the application, the application development side 140 may implement the generation of the release version of the application by invoking the plug-in 150 that is adapted to the development workflow of the application. In such embodiments, the plug-in 150 serves as a bridge between the build pipeline and the key management service.

The environment 100 also includes a user interface 120, which may be a web user interface (Web UI). The user interface 120 may be implemented at an electronic device of a developer or a manager. The user (which may also be referred to as “the developer or the manager”) may manage the user's application signing key by interacting with it through the user's web browser. Workflows such as key generation, self-signed certificate generation, CSR generation, key rotation, APP signing key access control, etc. are supported.

In the environment 100, the electronic device may be any type of device with computing power, including a terminal device or a server-side device. The terminal device may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device or any combination thereof, including accessories and peripherals of these devices or any combination thereof. The server may include, for example, a computing system/server, such as a mainframe, an edge computing node, an electronic device in a cloud environment, etc.

It should be understood that the structure and function of the environment 100 are described for illustrative purposes only, and are not intended to imply any limitation on the scope of the subject matter described herein.

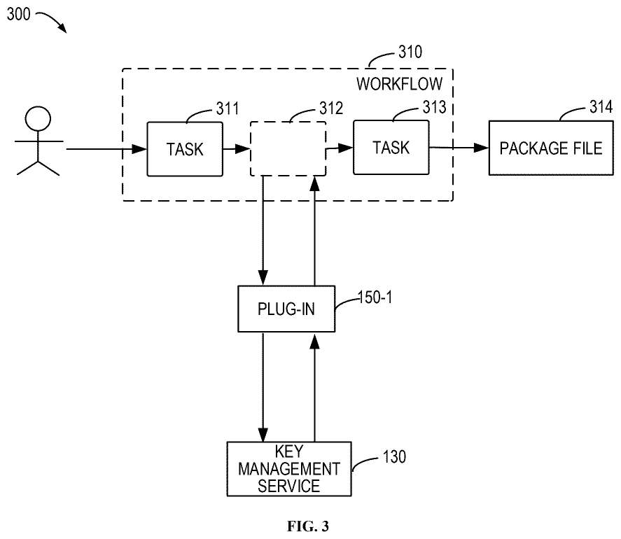

A solution for key management will be described below with reference to FIG. 2 first. FIG. 2 illustrates a schematic diagram of an example architecture 200 for key management according to some embodiments of the subject matter described herein. In the following, example embodiments will be described mainly with respect to the application development side 140. It should be understood that the actions described with respect to the application development side 140 may be performed by an electronic device corresponding to the application development side 140, or may be performed by the electronic device in cooperation with its server side (e.g., the key management service 130). The following description will refer to FIG. 1 for ease of understanding.

In some embodiments, the application development side 140 sends a signing request for an application to the key management service 130. The signing request sent by the application development side 140 to the key management service 130 includes target data to be signed for the application. In the example architecture 200, the application development side 140 forwards the signing request including the target data 211 to be signed for the application to the key management service 130. In some examples, the application may include an application that has been initially developed and is in an update, or may include an application that is in an initial development. The embodiments of the present disclosure are not limited in this respect.

In some examples, the application development side 140 may calculate the target data 211 to be signed for the application under development by using a hash function. It can be understood that the target data 211 to be signed corresponding to the application under development may be referred to as a payload to be signed corresponding to the application under development.

In the example architecture 200, after receiving the target data 211 sent by the application development side 140, the key management service 130 encrypts the target data 211 with the target key for the application to determine the digital signature 212 for the application.

The key management service 130 sends the digital signature to the application development side 140. For example, the application development side 140 downloads the digital signature 212 for the application from the key management service 130. The generation of the digital signature for the application by the key management service 130 will be described in detail below.

Then, the application development side 140 generates the release version of the application according to the digital signature. The application development side 140 embeds the digital signature 211 into the application under development, thereby generating the release version of the application. In some embodiments, the key management service 130 may host a digital certificate for the application. Correspondingly, the application development side 140 may receive the digital certificate for the application from the key management service.

For example, the signing request sent by the application development side 140 may additionally request the digital certificate. Alternatively, if the application development side 140 requests a signature, it may be defaulted that it also requests the digital certificate. In this way, the application development side 140 downloads the digital signature 212 and the digital certificate 213 for the application from the key management service 130.

In some embodiments, the application development side 140 may generate the release version of the application according to the digital signature and the digital certificate. For example, the application development side 140 embeds the digital signature 211 and the digital certificate 213 into the application under development, thereby generating the release version of the application.

In some embodiments, the solution for key management in the present disclosure is implemented at least partially through a plug-in adapted to the development workflow of the application. The application development side 140 may flexibly adapt to various workflows in the form of a plug-in. In the example architecture 200, the plug-in 150 obtains (e.g., calculates) the target data 211 and sends it to the key management service 130. In some embodiments, the plug-in 150 may invoke an application programming interface (API) provided by the key management service 130. In some embodiments, the plug-in 150 sends the target data 211 to be signed for the application to the key management service 130 and receives the digital signature 212 by invoking the application programming interface (API).

The plug-in may be integrated with a variety of different application development pipelines. Different developers of the same application may also conveniently develop with different pipelines without affecting the use of keys. This enables developers to store or host keys in the key management service instead of storing them locally. In this way, the problem of key leakage is solved.

Three example plug-ins adapted to the development workflow of the application will be described below with three examples, but this is only for example, and the present disclosure is not limited thereto. In some embodiments, the development workflow of the application includes a plurality of tasks, and the plug-in 150 is configured as one of the plurality of tasks. In some examples, a first plug-in is adapted to an application build tool for a generic package file for a type of operating system (e.g., the Android system) to implement signing of the generic package file. In some examples, the generic package file may be a package file in a first format, such as an “.apk” format and an “.aab” format.

The first plug-in is a tool plug-in in a compilation process, and is a custom signing system introduced in an open source project of a type of operating system (e.g., the Android system). The first plug-in may be integrated with the key management service to sign applications (e.g., package files in the “.apk” format and the “.aab” format) for the type of operating system (e.g., the Android system). The first plug-in allows a remote signing operation to be implemented in a typical development workflow of the operating system (e.g., the Android system). In a development workflow for the type of operating system (e.g., the Android system), a signing block of a package file (APK) of the application is generated and embedded into the original application. The generation of the APK signing block is performed remotely. The first plug-in may be implemented as an application building task, which is inserted between other tasks, allowing a signed APK to be finally generated.

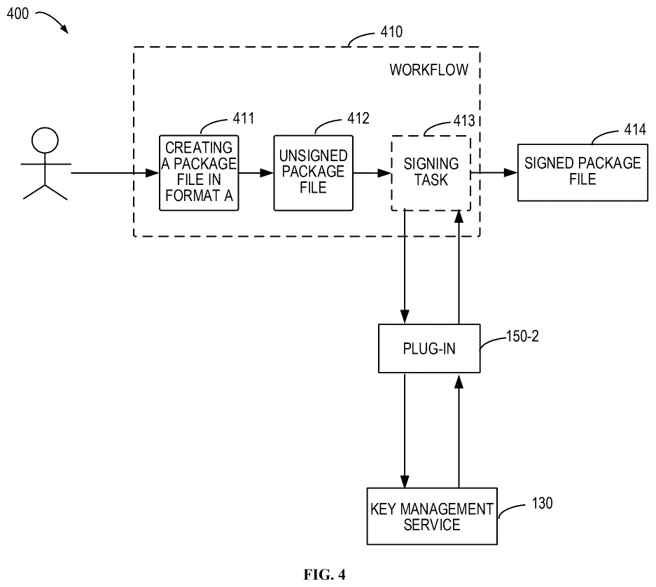

The process of generating the release version of the application by using the first plug-in for one of the plurality of tasks included in the development workflow will be described below with reference to FIG. 3. FIG. 3 illustrates a schematic diagram of an example architecture 300 for generating the release version of the application by using the first plug-in according to some embodiments of the present disclosure.

In the example architecture 300, the development workflow 310 includes a task 311, a task 312, a task 313, and so on. In the task 312 in the development workflow 310, the first plug-in 150-1 may calculate the target data to be signed for the application under development (sometimes also referred to as “payload”) by using a hash function. Subsequently, the first plug-in 150-1 sends the payload to the key management service 130. Correspondingly, the first plug-in 150-1 downloads the digital signature and the digital certificate from the key management service 130. Then, the first plug-in 150-1 embeds the digital signature and the digital certificate into a package file 314 to generate the final release version.

The key management service may keep detailed logs of all key use and management, and allows comprehensive tracking of user operations in case of user-level account leakage. Thus, it is convenient to maintain the integrity of the system and ensure that all operations are correctly recorded and tracked.

In some embodiments, the plug-in 150 may be configured as a file in a predetermined format. In some examples, the second plug-in 150-2 or the third plug-in 150-3 may be configured as a predetermined format (e.g., a .jar file). In some examples, the file in the predetermined format includes various data required to implement the process of generating the release version by using the plug-in.

In some embodiments, the second plug-in 150-2 may be a Java archive file (a .jar file) and may be used to sign applications (.apk and .aab) for a type of operating system (e.g., the Android system). The second plug-in 150-2 may be a stand-alone tool.

The third plug-in 150-3 is a Java archive file (a .jar file) for an application of a specific type of operating system. The third plug-in 150-3 may be obtained by modifying the open source information of the specific type of operating system. For example, the proprietary package file may be signed by modifying the hook that initially ingests the local key repository file. The proprietary package file may be a package file in a second format (e.g., a .hap/.app file).

In some embodiments, the application development side 140 invokes the file in the predetermined format in the predetermined step of the workflow. If the application development side 140 detects that the file in the predetermined format is invoked, it generates summary data of the application as the target data according to an unsigned package file of the application. Then, the release version is determined by adding the digital signature to the package file.

The process of generating the release version of the application by using the second plug-in will be described below with reference to FIG. 4. FIG. 4 illustrates a schematic diagram of an example architecture 400 for generating the release version of the application by using the second plug-in according to some embodiments of the present disclosure.

In the example architecture 400, the development workflow 410 includes creating a package file 411 in format A, an unsigned package file 412, and a signing task 413. For the signing task 413 in the development workflow 410, the second plug-in 150-2 calculates summary data to be signed for the application under development (sometimes also referred to as “payload”). It can be understood that the second plug-in 150-2 is invoked as the last step in the development workflow 410, that is, for the signing task 413, the second plug-in 150-2 calculates the summary data of the application.

Subsequently, the second plug-in 150-2 sends the payload to the key management service 130. Correspondingly, the second plug-in 150-2 downloads the digital signature and the digital certificate from the key management service 130. Then, the second plug-in 150-2 embeds the digital signature and the digital certificate into the signed package file 414 to generate the final release version.

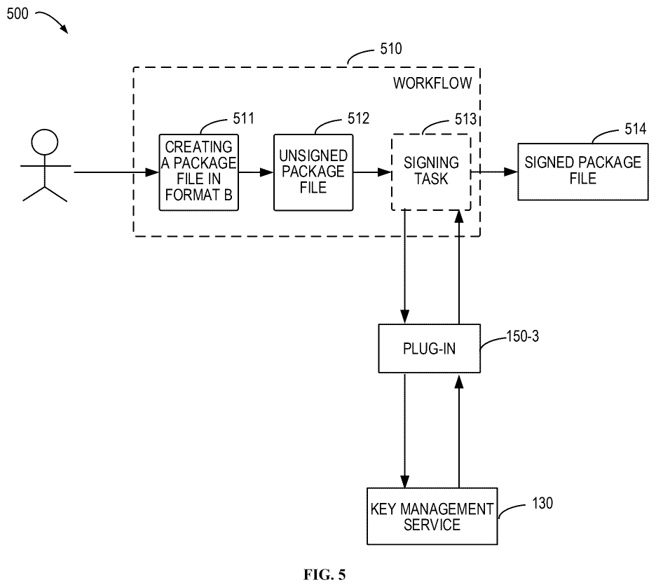

The process of generating the release version of the application by using the third plug-in will be described below with reference to FIG. 5. FIG. 5 illustrates a schematic diagram of an example architecture 500 for generating the release version of the application by using the third plug-in according to some embodiments of the present disclosure.

In the example architecture 500, the development workflow 510 includes creating a package file 511 in format B, an unsigned package file 512, and a signing task 513. For the signing task 513 in the development workflow 510, the third plug-in 150-3 calculates summary data to be signed for the application under development (sometimes also referred to as “payload”). It can be understood that the third plug-in 150-3 is invoked as the last step in the development workflow 410, that is, for the signing task 513, the third plug-in 150-3 calculates the summary data of the application.

Subsequently, the third plug-in 150-3 sends the payload to the key management service 130. Correspondingly, the third plug-in 150-3 downloads the digital signature and the digital certificate from the key management service 130. Then, the third plug-in 150-3 embeds the digital signature and the digital certificate into the signed package file 514 to generate the final release version.

The above describes an example implementation of using a plug-in to achieve integration with different types of pipelines. A plug-in is a software component that adds specific features to an existing computer program, and it is flexible. In the case of using a plug-in, the plug-in can help integrate the key management service into the build pipeline of the APP, for example, by intercepting the signing process, relaying the payload to the key management service and receiving the signature (as will be described in detail below). Through the use of plug-ins, the key management service can be compatible with different build pipelines for APP development. This enables developers of different pipelines to securely share the same key. In addition, since the key management service proposed in the present disclosure is easy to integrate with the pipeline, this can also promote the use range of the key management service.

The problem of compatibility with different build pipelines is solved by integrating the plug-in with the development workflow (also referred to as the build pipeline) of different application development sides and allowing the extension of new build pipelines in a modular manner. Correspondingly, by integrating the plug-in with different build pipelines, greater flexibility and scalability are allowed. Further, since the application signing key is only created in the key management service, the key is secure and will not leave the platform, thereby solving the problem of key leakage.

The solution for key management in the present disclosure is described above from the perspective of the application development side. The solution for key management in the present disclosure will be described below from the perspective of the key management service. The following description will continue to refer to FIG. 1 and FIG. 2 for ease of understanding.

In some embodiments, the key management service 130 receives, from the application development side, a signing request for an application under development, the signing request including target data to be signed for the application. The key management service 130 obtains a digital signature for the application by encrypting the target data with a target key for the application. Then, the key management service 130 sends the digital signature to the application development side for generating a release version of the application.

In some examples, the key management service 130 receives the target data 211 sent by the application development side 140. Correspondingly, the key management service 130 encrypts the target data 211 with the target key for the application to obtain the digital signature 212. Then, the key management service 130 sends the digital signature 212 to the application development side 140 for generating the release version of the application.

In some embodiments, the key management service 130 may also send a digital certificate to the application development side for generating the release version. In some examples, the key management service 130 may automatically send a corresponding digital certificate in response to the signing request. Alternatively, an indication of the signing request may include a request for the digital certificate, that is, the key management service 130 sends the digital certificate to the application development side 140 in response to the signing request.

It can be understood that the key management service 130 may obtain the digital signature 212 and the digital certificate 213 by encrypting the target data 211 with the target key for the application. Then, the key management service 130 sends the digital signature 212 and the digital certificate 213 to the application development side 140 for generating the release version of the application.

In some embodiments, the key management service 130 verifies, based on key management information related to the application, whether an initiator of the signing request has an access permission to a key for the application. Then, if the key management service 130 detects that the initiator passes the verification, the target data is encrypted with the target key.

In some examples, if a user B initiates a signing request for an application A, the key management service 130 verifies, based on key management information related to the application A, whether the user B has an access permission to a key for the application A. If the user B has the access permission to the key for the application A, the key management service 130 encrypts the target data 211 with the target key.

Thus, by setting up an appropriate authentication and authorization system, it can be ensured that users with appropriate permissions can manage and sign applications. Thus, it is ensured that only authorized users can access sensitive information and functions. That is, the key management service performs authentication and authorization control, which can solve the problem of unauthorized key use.

In some embodiments, the key management service 130 may obtain the key management information in the following manner. The key management service 130 presents a key configuration interface for the application, the key configuration interface including one or more configuration options related to key management of the application. Then, the key management service 130 receives the key management information via the one or more configuration options.

In some embodiments, the user may set the key management information through a web user interface (Web UI) presented by the key management service 130. The web user interface allows the user to manage the user's application signing key by invoking an application programming interface (API) provided by the key management service 130. Thus, the user can simply and efficiently manage keys through the web user interface.

In some embodiments, the one or more configuration options included in the key configuration interface include at least one of: generation of a signing key for the application, generation of a self-signed certificate, generation of a certificate signing request for the application, rotation of the signing key for the application, or access permission to the signing key for the application.

In some examples, by supporting the generation of a new application signing key, the generation of a new self-signed certificate, the generation of a new certificate signing request, the rotation of the application signing key, or the configuration of access to the application signing key, the key configuration interface enables the user to efficiently and simply manage keys. In this way, the user (sometimes also referred to as “developer/manager”) can easily organize and access their keys, thereby saving the user's time and effort in the development process.

In conclusion, through the present disclosure, signing key management can be effectively unified. Correspondingly, the support of the key management workflow through the key configuration interface can improve usability. Further, since the application signing key is only created in the key management service, the key is secure and will never leave the platform, thereby solving the problem of key leakage.

### Example Process

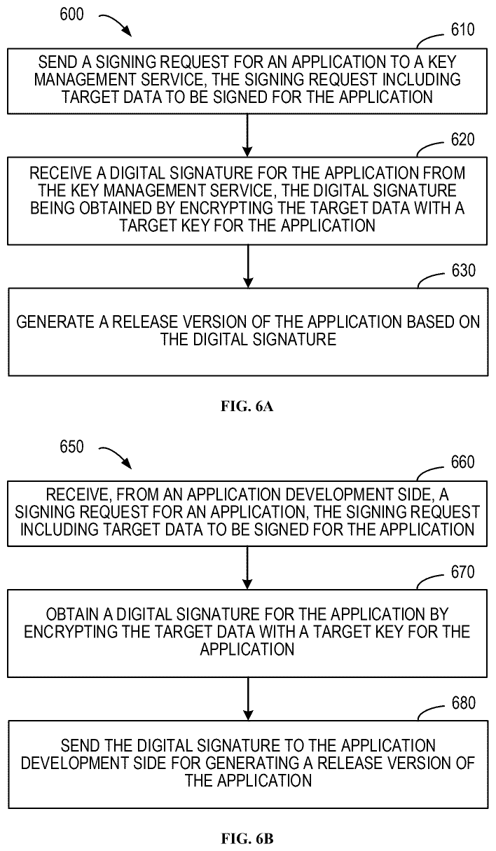

FIG. 6A illustrates a flowchart of a process 600 for key management according to some embodiments of the subject matter described herein. The process 600 may be implemented at the application development side 140. The process 600 will be described below with reference to FIG. 1.

At block 610, the application development side 140 sends a signing request for an application to a key management service, the signing request including target data to be signed for the application.

At block 620, the application development side 140 receives a digital signature for the application from the key management service, the digital signature being obtained by encrypting the target data with a target key for the application.

At block 630, the application development side 140 generates a release version of the application based on the digital signature.

In some embodiments, the process 600 may further include: receiving a digital certificate for the application from the key management service, and generating the release version includes: generating the release version based on the digital signature and the digital certificate.

In some embodiments, the method implemented by the process 600 may be implemented at least partially through a plug-in adapted to the development workflow of the application.

In some embodiments, the development workflow may include a plurality of tasks, and the plug-in is configured as one of the plurality of tasks.

In some embodiments, the plug-in may be configured as a file in a predetermined format, and the method may further include: invoking the file in the predetermined format in a predetermined step of the development workflow.

In some embodiments, the process 600 may further include: in response to the file in the predetermined format being invoked, generating summary data of the application as the target data based on an unsigned package file of the application, and generating the release version may include: obtaining the release version by adding the digital signature to the package file.

FIG. 6B illustrates a flowchart of a process 650 for key management according to some embodiments of the subject matter described herein. The process 650 may be implemented at the key management service 130. The process 650 will be described below with reference to FIG. 1.

At block 660, the key management service 130 receives, from the application development side 140, a signing request for an application, the signing request including target data to be signed for the application. At block 670, the key management service 130 obtains a digital signature for the application by encrypting the target data with a target key for the application. At block 680, the key management service 130 sends the digital signature to the application development side 140 for generating a release version of the application.

In some embodiments, the process 650 may further include: in response to the signing request, sending a digital certificate for the application to the application development side for generating the release version.

In some embodiments, the process 650 may further include: verifying, based on key management information related to the application, whether an initiator of the signing request has an access permission to a key for the application; and in response to the initiator passing the verification, encrypting the target data with the target key.

In some embodiments, the key management information may be obtained by: presenting a key configuration interface for the application, the key configuration interface including one or more configuration options related to key management of the application; and receiving the key management information via the one or more configuration options.

In some embodiments, the one or more configuration options may include at least one of: generation of a signing key for the application, generation of a self-signed certificate, generation of a certificate signing request for the application, rotation of the signing key for the application, or access permission to the signing key for the application.

### Example Apparatus and Device

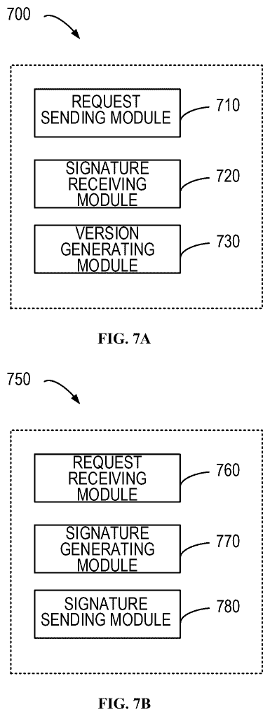

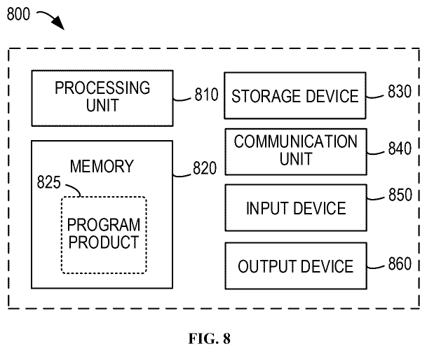

FIG. 7A illustrates a schematic structural block diagram of an apparatus 700 for key management according to some embodiments of the subject matter described herein. The apparatus 700 may be implemented or included in the application development side 140. Various modules/components in the apparatus 700 may be implemented by hardware, software, firmware, or any combination thereof.

As shown, the apparatus 700 includes a request sending module 710 configured to send a signing request for an application to a key management service, the signing request including target data to be signed for the application. The apparatus 700 also includes a signature receiving module 720 configured to receive a digital signature for the application from the key management service, the digital signature being obtained by encrypting the target data with a target key for the application. The apparatus 700 further includes a version generating module 730 configured to generate a release version of the application based on the digital signature.

In some embodiments, the apparatus 700 further includes a certificate receiving module configured to receive a digital certificate for the application from the key management service, and the generation module 730 is further configured to generate the release version based on the digital signature and the digital certificate.

In some embodiments, the method is implemented at least partially through a plug-in adapted to the development workflow of the application.

In some embodiments, the development workflow includes a plurality of tasks, and the plug-in is configured as one of the plurality of tasks.

In some embodiments, the plug-in is configured as a file in a predetermined format, and the apparatus 700 further includes an invoking module configured to invoke the file in the predetermined format in a predetermined step of the development workflow.

In some embodiments, the apparatus 700 further includes a data generation module configured to, in response to the file in the predetermined format being invoked, generate summary data of the application as the target data based on an unsigned package file of the application, and the generation module 730 is further configured to obtain the release version by adding the digital signature to the package file.

FIG. 7B illustrates a schematic structural block diagram of an apparatus 750 for key management according to some embodiments of the subject matter described herein. The apparatus 750 may be implemented or included in the key management service 130. Various modules/components in the apparatus 750 may be implemented by hardware, software, firmware, or any combination thereof.

As shown, the apparatus 750 includes a request receiving module 760 configured to receive, from an application development side, a signing request for an application, the signing request including target data to be signed for the application; a signature generating module 770 configured to obtain a digital signature for the application by encrypting the target data with a target key for the application; and a signature sending module 780 configured to send the digital signature to the application development side for generating a release version of the application.

In some embodiments, the signature sending module 780 is further configured to, in response to the signing request, send a digital certificate for the application to the application development side for generating the release version.

In some embodiments, the apparatus 750 further includes a data encryption module configured to verify, based on key management information related to the application, whether an initiator of the signing request has an access permission to a key for the application; and in response to the initiator passing the verification, encrypt the target data with the target key.

In some embodiments, the key management information is obtained by: presenting a key configuration interface for the application, the key configuration interface including one or more configuration options related to key management of the application; and receiving the key management information via the one or more configuration options.

In some embodiments, the one or more configuration options include at least one of: generation of a signing key for the application, generation of a self-signed certificate, generation of a certificate signing request for the application, rotation of the signing key for the application, or access permission to the signing key for the application.

FIG. 8 illustrates a block diagram of an electronic device 800 in which one or more embodiments of the subject matter described herein may be implemented. It should be understood that the electronic device 800 shown in FIG. 8 is only for example, and should not constitute any limitation on the function and scope of the embodiments described herein. The electronic device 800 shown in FIG. 8 may be used to implement the electronic device 110 in FIG. 1.

As shown in FIG. 8, the electronic device 800 is in the form of a general-purpose electronic device. The components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and may perform various processes according to a program stored in the memory 820. In a multi-processor system, multiple processing units execute computer-executable instructions in parallel to improve the parallel processing capability of the electronic device 800.

The electronic device 800 typically includes a plurality of computer storage media. Such media may be any available media that may be accessed by the electronic device 800, including but not limited to volatile and non-volatile media, removable and non-removable media. The memory 820 may be a volatile memory (e.g., register, cache, random access memory (RAM)), a non-volatile memory (e.g., read-only memory (ROM), electrically erasable programmable read-only memory (EEPROM), flash memory), or some combination thereof. The storage device 830 may be a removable or non-removable medium and may include a machine-readable medium, such as a flash drive, a disk, or any other medium, which may be capable of storing information and/or data and may be accessed within the electronic device 800.

The electronic device 800 may further include additional removable/non-removable, volatile/non-volatile storage media. Although not shown in FIG. 8, a disk drive for reading or writing from a removable, non-volatile disk (e.g., “floppy disk”) and an optical disk drive for reading or writing from a removable, non-volatile optical disk may be provided. In these cases, each drive may be connected to a bus (not shown) by one or more data media interfaces. The memory 820 may include a computer program product 825 having one or more program modules configured to perform various methods or actions of various embodiments of the present disclosure.

The communication unit 840 implements communication with other electronic devices through a communication medium. Additionally, the functions of the components of the electronic device 800 may be implemented in a single computing cluster or multiple computing machines that may communicate through communication connections. Thus, the electronic device 800 may operate in a networked environment using logical connections to one or more other servers, network personal computers (PCs), or another network node.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown), such as a storage device, a display device, etc., communicate with one or more devices that enable a user to interact with the electronic device 800, or communicate with any device (e.g., a network card, a modem, etc.) that enables the electronic device 800 to communicate with one or more other electronic devices, through the communication unit 840 as needed. Such communication may be performed via an input/output (I/O) interface (not shown).

According to an example implementation of the subject matter described herein, there is provided a computer-readable storage medium having computer-executable instructions stored thereon, the computer-executable instructions, when executed by a processor, implement the method described above. According to an example implementation of the subject matter described herein, there is also provided a computer program product tangibly stored on a non-transitory computer-readable medium and including computer-executable instructions, the computer-executable instructions, when executed by a processor, implement the method described above.

Various aspects of the subject matter described herein are described herein with reference to flowcharts and/or block diagrams of methods, apparatuses, devices and computer program products implemented according to the subject matter described herein. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine such that the instructions, when executed by the processing unit of the computer or the other programmable data processing apparatus, produce an apparatus for implementing the functions/acts specified in one or more blocks of the flowcharts and/or block diagrams. These computer-readable program instructions may also be stored in a computer-readable storage medium, and these instructions cause a computer, a programmable data processing apparatus and/or other devices to work in a specific manner, such that the computer-readable medium storing the instructions includes an article of manufacture including instructions for implementing various aspects of the functions/acts specified in one or more blocks of the flowcharts and/or block diagrams.

The computer-readable program instructions may be loaded onto a computer, other programmable data processing apparatus, or other devices, such that a series of operational steps are executed on the computer, the other programmable data processing apparatus, or the other devices to produce a computer-implemented process, such that the instructions executed on the computer, the other programmable data processing apparatus, or the other devices implement the functions/acts specified in one or more blocks of the flowcharts and/or block diagrams.

The flowcharts and block diagrams in the drawings illustrate the architecture, functionality, and operation of possible implementations of systems, methods and computer program products according to various implementations of the subject matter described herein. In this regard, each block in the flowcharts or block diagrams may represent a module, a program segment, or a portion of instructions, which includes one or more executable instructions for implementing specified logical functions. In some alternative implementations, the functions noted in the blocks may also occur out of the order noted in the drawings. For example, two blocks shown in succession may, in fact, be executed substantially concurrently, or the blocks may sometimes be executed in a reverse order, depending upon the functionality involved. It is also noted that, each block of the block diagrams and/or flowcharts, and combinations of blocks in the block diagrams and/or flowcharts, may be implemented by special purpose hardware-based systems that perform the specified functions or acts, or combinations of special purpose hardware and computer instructions.

Various implementations of the subject matter described herein have been described above, and the above description is for example, not exhaustive, and is not limited to the disclosed implementations. Many modifications and variations will be apparent to those of ordinary skill in the art without departing from the scope and spirit of the described implementations. The terminology used herein was chosen in order to best explain the principles of the implementations, the practical application or the improvement of the technology in the market, or to enable others of ordinary skill in the art to understand the implementations disclosed herein.

1. A method for key management, comprising:
sending a signing request for an application to a key management service, the signing request comprising target data to be signed for the application;
receiving a digital signature for the application from the key management service, the digital signature being obtained by encrypting the target data with a target key for the application; and
generating a release version of the application based on the digital signature.

2. The method of claim 1, further comprising:
receiving a digital certificate for the application from the key management service, and
wherein generating the release version comprises:
generating the release version based on the digital signature and the digital certificate.

3. The method of claim 1, wherein the method is implemented at least partially through a plug-in adapted to a development workflow of the application.

4. The method of claim 3, wherein the development workflow comprises a plurality of tasks, and the plug-in is configured as one of the plurality of tasks.

5. The method of claim 3, wherein the plug-in is configured as a file in a predetermined format, and the method further comprises:
invoking the file in the predetermined format in a predetermined step of the development workflow.

6. The method of claim 5, further comprising:
in response to the file in the predetermined format being invoked, generating summary data of the application as the target data based on an unsigned package file of the application, and
wherein generating the release version comprises:
obtaining the release version by adding the digital signature to the package file.

7. A method for key management, comprising:
receiving, from an application development side, a signing request for an application, the signing request comprising target data to be signed for the application;
obtaining a digital signature for the application by encrypting the target data with a target key for the application; and
sending the digital signature to the application development side for generating a release version of the application.

8. The method of claim 7, further comprising:
in response to the signing request, sending a digital certificate for the application to the application development side for generating the release version.

9. The method of claim 7, further comprising:
verifying, based on key management information related to the application, whether an initiator of the signing request has an access permission to a key for the application; and
in response to the initiator passing the verification, encrypting the target data with the target key.

10. The method of claim 9, wherein the key management information is obtained by:
presenting a key configuration interface for the application, the key configuration interface comprising one or more configuration options related to key management of the application; and
receiving the key management information via the one or more configuration options.

11. The method of claim 10, wherein the one or more configuration options comprise at least one of:
generation of a signing key for the application,
generation of a self-signed certificate,
generation of a certificate signing request for the application,
rotation of the signing key for the application, or
access permission to the signing key for the application.

12. An electronic device, comprising:
at least one processing unit; and
at least one memory, the at least one memory being coupled to the at least one processing unit and storing instructions executable by the at least one processing unit, the instructions, when executed by the at least one processing unit, causing the device to perform acts comprising:
sending a signing request for an application to a key management service, the signing request comprising target data to be signed for the application;
receiving a digital signature for the application from the key management service, the digital signature being obtained by encrypting the target data with a target key for the application; and
generating a release version of the application based on the digital signature.

13. The electronic device of claim 12, wherein the acts further comprise:
receiving a digital certificate for the application from the key management service, and
wherein generating the release version comprises:
generating the release version based on the digital signature and the digital certificate.

14. The electronic device of claim 12, wherein the acts are implemented at least partially through a plug-in adapted to a development workflow of the application.

15. The electronic device of claim 14, wherein the development workflow comprises a plurality of tasks, and the plug-in is configured as one of the plurality of tasks.

16. The electronic device of claim 14, wherein the plug-in is configured as a file in a predetermined format, and the acts further comprise:
invoking the file in the predetermined format in a predetermined step of the development workflow.

17. The electronic device of claim 16, wherein the acts further comprise:
in response to the file in the predetermined format being invoked, generating summary data of the application as the target data based on an unsigned package file of the application, and
wherein generating the release version comprises:
obtaining the release version by adding the digital signature to the package file.
